(19) United States
(12) Patent Application Publication
(10) Pub. No.: US 2005/0080861 A1
(43) Pub. Date: Apr. 14, 2005

(54) Selectively displaying email folders

(76) Inventors: W. Todd Daniell, Marietta, GA (US); Dale W. Malik, Dunwoody, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/685,834

(22) Filed: Oct. 14, 2003

(51) Int. Cl. G06F 15/16

(52) U.S. Cl. 709/206; 709/223

(57) ABSTRACT

Group email and individual user email are provided. The group email is accessible by each member of a predefined group. The individual-user email is accessible by an individual. Additionally, an email application, which is executable by the individual user, is provided. The email application is configured to display the group email and the individual user email in response to being executed by the individual user.

### CROSS-REFERENCE TO RELATED APPLICATIONS

The following patent applications are incorporated by reference herein, as if set forth in their entireties: U.S. patent application Ser. No. 10/274,405, filed Oct. 18, 2002; U.S. patent application Ser. No. 10/274,408, filed Oct. 18, 2002; U.S. patent application Ser. No. 10/274,478, filed Oct. 18, 2002; U.S. patent application Ser. No. 10/325,044, filed Dec. 19, 2002; U.S. patent application Ser. No. 10/325,317, filed Dec. 19, 2002; U.S. patent application Ser. No. 10/326,249, filed on Dec. 19, 2002; U.S. patent application Ser. No. 10/368,099, filed Feb. 18, 2003; U.S. patent application Ser. No. 10/408,498, filed on Apr. 7, 2003; U.S. patent application [attorney docket no. 190250-1310], entitled “USER INTERFACE FOR A COMMUNICATION SUITE,” filed on Oct. 14, 2003; U.S. provisional patent application having Ser. No. 60/411,336, filed Sep. 17, 2002; U.S. provisional patent application having Ser. No. 60/411,438, filed Sep. 17, 2002; U.S. provisional patent application having Ser. No. 60/416,916, filed Oct. 8, 2002; U.S. provisional patent application having Ser. No. 60/419,613, filed Oct. 17, 2002; U.S. provisional patent application having Ser. No. 60/426,145, filed Nov. 14, 2002; U.S. provisional patent application having Ser. No. 60/426,146, filed Nov. 14, 2002; U.S. provisional patent application having Ser. No. 60/426,422, filed Nov. 14, 2002; U.S. provisional patent application having Ser. No. 60/426,432, filed Nov. 14, 2002; and U.S. provisional patent application having Ser. No. 60/426,440, filed Nov. 14, 2002.

### FIELD OF THE DISCLOSURE

The present disclosure relates generally to digital communication and, more particularly, to email.

### BACKGROUND

When an individual contracts with an Internet service provider (ISP) for Internet-related services, the ISP typically provides one or more email mailboxes for that individual, with each mailbox having a finite amount of storage space for incoming email messages. Often, the individual distributes the multiple email mailboxes to various family members, who then have email access through the ISP.

Typically, the email mailboxes are segregated such that an email message sent to one email mailbox is only accessible by the assigned user of that email mailbox. For example, if a father's email mailbox and a son's email mailbox are separately established, email messages that are sent to the father's email mailbox are typically accessible by the father, while email messages that are sent to the son's email mailbox are typically accessible by the son. Consequently, if an email sender wishes to send an email message to both the father and the son, then the sender is often required to send the email message to two separate individuals. Thus, when the email message is sent, one copy of the message is delivered to the father's email mailbox, while another copy of the email message is delivered to the son's email mailbox. This type of duplicative email storage results in a depletion of the storage space that is provided by the ISP.

A need, therefore, exists in the industry to remedy the aforementioned and other problems.

### SUMMARY

The preferred embodiments, among others, of the present disclosure provide for managing multiple email messages. As such, some embodiments, among others include group email, first individual-user email, and an email application. The group email is accessible by each member of a predefined group. The first individual-user email is accessible by a first user. The email application is executable by the first user. Upon execution, the email application is configured to display the group email and the first individual-user email.

Other systems, devices, methods, features, and advantages will be or become apparent to one with skill in the art upon examination of the following drawings and detailed description. It is intended that all such additional systems, methods, features, and advantages be included within this description.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram showing an embodiment of a network environment that is capable of handling email traffic.

FIG. 2A is a block diagram showing an embodiment of the Internet service provider (ISP) and a workstation from FIG. 1 in greater detail.

FIG. 2B is a block diagram showing an embodiment of the email client of FIG. 2A in greater detail.

FIG. 3 is a block diagram showing an embodiment of the organization of data structures in the storage device of FIG. 2B.

FIG. 4A is a block diagram showing an example user interface for an embodiment of an individual user email folder that selectively displays the data structures of FIG. 3.

FIG. 4B is a block diagram showing an example user interface for an embodiment of a group email folder that selectively displays the data structures of FIG. 3.

FIG. 5A is a block diagram showing an example user interface for an embodiment of an individual user email folder that selectively displays the data structures of FIG. 3.

FIG. 6 is a block diagram showing an example user interface for an embodiment of a group email folder that selectively displays the data structures of FIG. 3.

FIG. 7 is a flowchart showing an embodiment of a method for managing multiple email mailboxes.

FIG. 8 is a flowchart showing yet another embodiment of a method for storing a user's email and instant messaging (IM) information.

FIGS. 9 through 16 are block diagrams showing example preferences or properties associated with instant messaging (IM).

FIGS. 17 and 18 are block diagrams showing example preferences or properties associated with email.

### DETAILED DESCRIPTION OF THE PREFERRED EMBODIMENTS

Reference is now made to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

When an individual establishes an account with an Internet service provider (ISP), that ISP often provides email access to that individual. For example, ISPs often provide multiple email mailboxes to the individual so that the user may establish a separate email mailbox for each of his or her family member users, including himself or herself as a user. Alternatively, the multiple email mailboxes permit the individual to establish one email mailbox for personal use while establishing another email mailbox for business purposes. Unfortunately, many of the ISPs limit the amount of storage space for email messages. In several embodiments of the present disclosure, group email mailboxes are described in which a single email may be directed to members of a group by establishing a group email mailbox. By providing access to the group email mailbox to each member, a single email message may be sent to multiple recipients. In other embodiments, techniques are presented for managing group email messages. Furthermore, some embodiments are shown to prevent unauthorized access to other email mailboxes. For example, if one family member has one email mailbox, and another family member has another email mailbox, then each family member may access only those email mailboxes that the family member is given permission to access. In this regard, several embodiments are described that teach the managing of multiple email mailboxes.

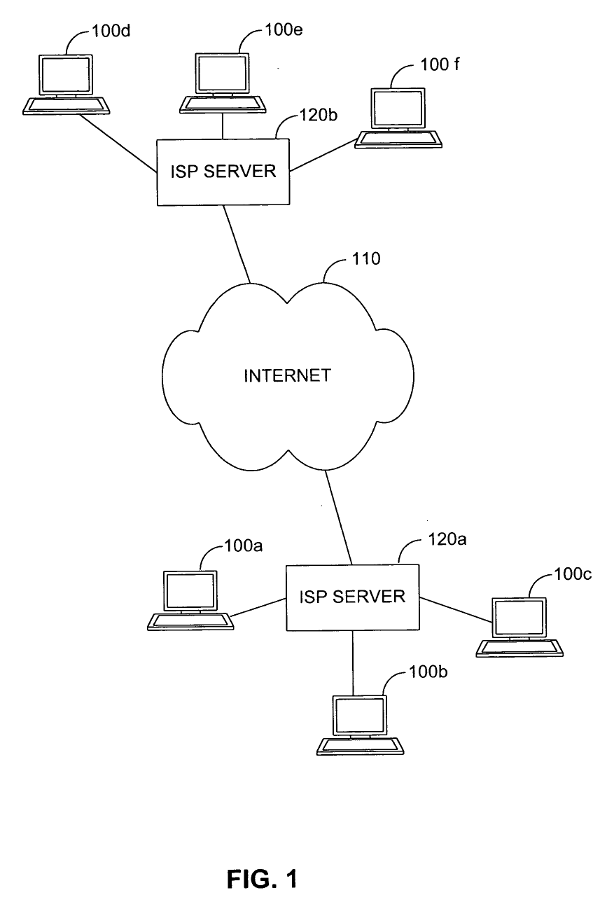

Referring now to FIG. 1, shown is a block diagram illustrating an architecture used for email transport and delivery used in some embodiments of the present disclosure. Each of a plurality of remote computers 100a . . . 100f access the Internet 110 (or other network) through a local Internet service provider (ISP) server 120a, 120b (or other gateway systems). It should be recognized by one skilled in the art that the ISP server 120a, 120b can offer access to the Internet 110 through a plethora of connection types, including a digital subscriber line (DSL) service, an integrated services digital network (ISDN) service, an analog dial-up service, ethernet, T-1, cable, powerline or any other service for transmitting data through a network, and to and from the remote computers 110a . . . 100f. Each of the ISP servers 120a, 120b, in turn, is connected to the Internet 110. This Internet connectivity enables the ISP servers 120a, 120b and other servers connected to the Internet to transfer information amongst the servers 120a, 120b using various universal protocols recognized by the servers. In some embodiments, the ISP servers 120a, 120b are effectively part of the Internet.

With specific regard to email, the ISP servers 120a, 120b include, in one embodiment, both a post office protocol 3 (POP3) server and a simple mail transfer protocol (SMTP) server with a multipurpose Internet mail extension (MIME). An email client on each of the computers 110a . . . 100f, in some embodiments, includes a POP3 component and an SMTP component with MIME encapsulation for non-ASCII attachments. The SMTP component on a computer 110a . . . 100c will transfer an email message in the SMTP format to the SMTP server residing on an ISP server 120a. The SMTP server then transfers it to the correct ISP server 120b where it is stored on the POP3 server. Alternatively, one skilled in the art should recognize that the POP3 server can be replaced by, among others, an Internet message access protocol 4 (IMAP4) server which can perform all of the POP3 functions and features additional functions for flexibility and efficiency. As mentioned before, the computers 100a . . . 100f each have an email client that includes, in some embodiments, a POP3 component. The POP3 component on the computer 100d . . . 100f can contact the POP3 server on the local ISP server 120b (or other ISP servers) and retrieve messages for the user logged in from the client on the respective computer 110d . . . 100f.

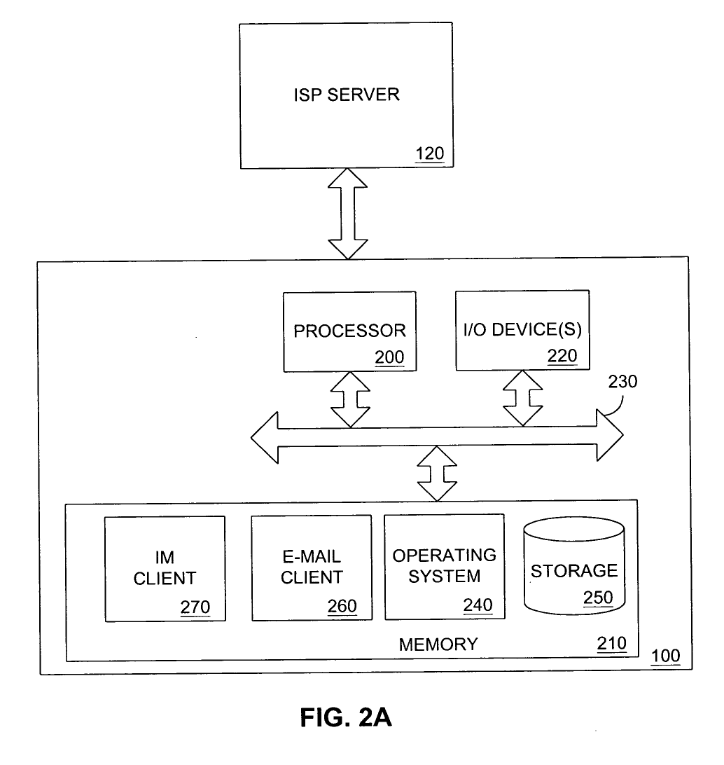

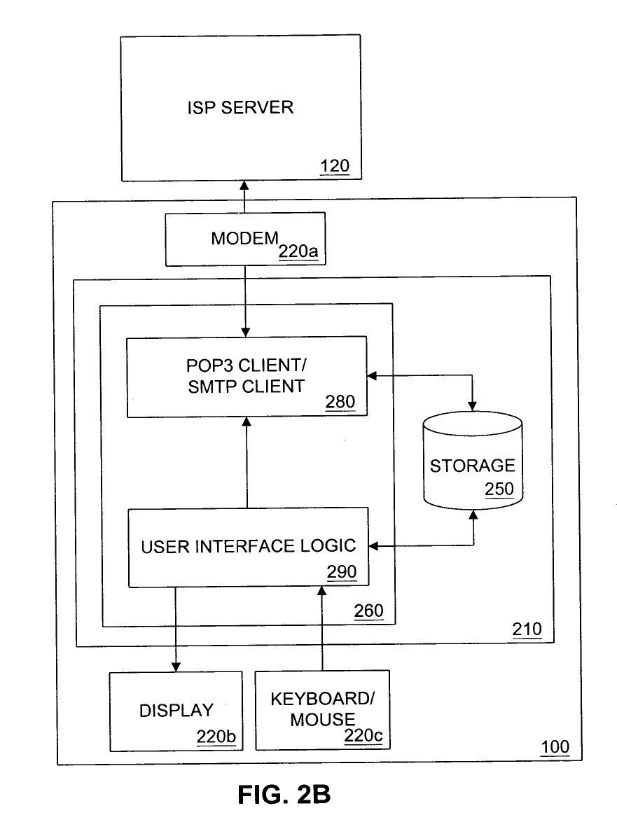

Referring now to FIG. 2A, shown is a block diagram of a computer system in accordance with one embodiment, among others, of the present disclosure. As known to those skilled in the art, a computer system typically includes a processor 200, memory 210 and input/output (I/O) device(s) 220, all communicating over a bus 230. The memory typically includes the operating system 240 and non-volatile storage 250. The operating system is typically stored in non-volatile memory while the computer 100 is turned off, and loaded into volatile memory upon start-up, where it can be executed by the processor 200. In the present embodiment, the memory 210 includes an email client 260 which enables the computer to send/receive email messages to/from the ISP server 120 through an I/O device 220 such as an analog modem, DSL modem, ISDN modem or ethernet card, among others. The email client 260, as discussed above, typically includes a retrieval component (such as POP3) to receive email, a transfer component (such as SMTP) to send email, and some sort of user interface logic to format the output to provide a display that can be understood by the computer user. Additionally, the memory 210 includes an instant messaging (IM) client 270, which enables the computer to send/receive IM messages over the network, in accordance with known methods.

Referring now to FIG. 2B, shown is a more detailed diagram of the email client 260 of FIG. 2A. As mentioned above, the email client includes POP3 and SMTP components 280. As one skilled in the art will recognize, these protocols merely relate to retrieving and sending email. As such, it is intended that other protocols that operate to send and retrieve email, such as IMAP4, among others, are intended to be included herein. The POP3 component 280 in this embodiment typically downloads email from the ISP server 120 through an I/O modem device 220a, and stores the email in non-volatile storage 250. Moreover, this embodiment, among others, is typically set up to retrieve messages for more than one email mailbox. Additionally, while a client email program is described herein, it should be appreciated that the functionality at the client may be transferred to an email server. In other words, an email server may be configured to execute the various functions described below, thereby permitting similar organization at the server level, rather than at the client level. The server-based embodiments may facilitate email organization and group email display for web-based email. Some server-based implementations, such as Microsoft® Exchange Server, may provide access to mailboxes using proprietary interfaces and architecture. Other server-based implementations, such as web-based email, may provide access to mailboxes using a conventional web browser, which resides at the client.

In some server embodiments, multiple individual users are provided direct access to the group mailboxes using their respective individual user names and passwords. In this regard, unlike client-based implementations, server processes are configured to manage user access, track email access by individual users, provide authentication, etc. directly at the server for server-based implementations, thereby avoiding downloading of email messages, as in POP3 client-based embodiments, and curtailing rules-based message segregation. Some embodiments are also unlike server-based implementations which implement rules for transferring messages to group email folders on the server, which are then accessible by members of the group. In other words, unlike systems in which email messages are transferred to a “public” folder on a server and subsequently accessible by members of a group, several server-based implementations of the present disclosure provide direct access to a group mailbox for members of the group.

It should be appreciated that the functions associated with the various email folders in the client-based implementation will have a corresponding server-based function for server-based implementations. Thus, while some embodiments are shown below as client-based implementations having email folders, it should be appreciated that corresponding server-based embodiments may be implemented for email mailboxes on the server.

User interface logic 290 included within the email client 260 can retrieve the messages from the non-volatile storage, format the information, and send the formatted information to the I/O display device 220b. In particular, user interface logic 290 of this embodiment, among others, of the present disclosure is configured to parse the data retrieved from non-volatile storage 250. Specifically, user interface logic 290 can separate email messages according to an associated “To:” email address or “From:” email address, and display multiple folder collections corresponding to several email addresses. As discussed below, one of the folder collections may be a group folder collection that provides access to group messages from a group mailbox for multiple users. User interface logic 290 can also be configured to display summary information from each of the folders, such as how many messages are contained in each of the subfolders of the folders. One skilled in the art will recognize that in practice, user interface logic 290 typically calls various functions within the operating system that are relayed through the processor 200 (FIG. 2A) before being sent to the display device 220b.

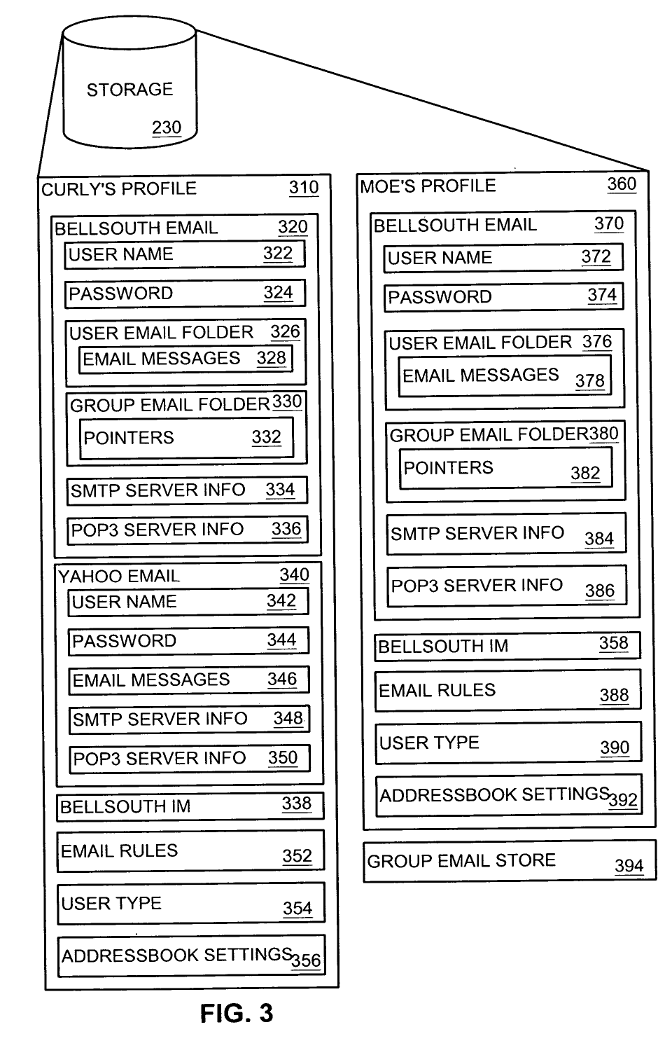

When a user chooses to read a message, the user uses an input device 220c to select a message from the active folder. In some embodiments, once selected, a “read” window may open, enabling the user to read the text associated with the selected message. In alternative embodiments, the user may select the message from the active folder and “preview” the email message in a separate preview pane. As described above, in some embodiments, the email client 260 displays both a user email folder and a group email folder, thereby permitting a user to access email messages in either the user email folder or the group email folder. Further details related to the user email folder and the group email folder are described with reference to FIGS. 3 through 7.

Upon a user choosing to write a new email or reply to an email, user interface logic 290 in one embodiment, among others, of the present disclosure will open a “write” window that will enable the user to compose a message. Moreover, user interface logic 290, upon opening the window, will stamp the message with the currently active folder, or alternatively, will stamp a reply from the email address at which it was received. One skilled in the art will understand that the user typically inputs the email using an I/O device 220c such as a keyboard or mouse. Moreover, one skilled in the art will recognize other input devices on which text and commands can be input, such as speech recognition software, and each of the alternative input devices are intended to be included within the scope of this disclosure. Upon completion of the email, the user can instruct the email client to send the email. User interface logic 290 will send the message to non-volatile storage 250, if the user has set up the option to save sent messages, and transfer the message to the SMTP component 280. The SMTP component 280 will then transfer email to the ISP server 120 over the modem 220a, if the computer is on-line. If the computer is not on-line the SMTP component 280 will send the message to be stored in non-volatile storage 250 pending being sent the next time the computer is connected to the ISP server 120. As known to those skilled in the art, there are many different ways to facilitate reading and writing a message, and the disclosure presented herein should not be limited to a particular method for displaying the text of a message or for composing a message.

FIG. 3 is a block diagram showing an embodiment of the organization of data structures in the storage device 230 of FIG. 2B. As shown in FIG. 3, in some embodiments, the storage device 230 has profiles 310, 360 for each of the email users as well as a group email store 394. The group email store 394 stores incoming email messages that are directed to a group. The profiles are a collection of settings for each of the user's email folders, including the settings for the group email folder in the event that a particular user accesses the group email folder. Thus, for example, when a particular individual user logs in at an email client, that individual user's settings will be used for email access for the duration that the individual user is logged in. Similarly, when another individual user logs in at an email client, that other individual user's settings will be used for email access for the duration of the email session.

In addition to email preferences and settings, the profiles may include a collection of settings for each of the user's instant messaging (IM) accounts. Thus, for example, given two authorized users, Curly and Moe, the data structure in the storage device 230 will include Curly's profile and Moe's profile.

Curly's profile may include a listing of all of Curly's email mailboxes and folders as well as all of Curly's IM accounts. Thus, for example, if Curly has a BellSouth® email mailbox, a Yahoo® email mailbox, and a BellSouth® IM account, then Curly's profile will include a BellSouth® email profile folder 320, a Yahoo® email profile profile folder 340, and a BellSouth® IM profile profile folder 338.

The BellSouth® email profile folder 320 has a user name 322 and a password 324 for the user's BellSouth® email mailbox. Similarly the Yahoo® email profile profile folder 340 has a user name 342 and a password 344 for the user's Yahoo® email mailbox. In addition to the user name and password, the BellSouth® email profile folder 320 includes a user email profile folder 326, which has email messages 328 that are directed to Curly. In other embodiments, the email messages may be stored in a separate mail store, with the email profile folder 326 having pointers to the various email messages for the corresponding user in the mail store. Also, the BellSouth® email profile folder 320 has a group email profile folder 330, which has pointers to email messages that are directed to an email address of a group, of which Curly is a member. The group email messages are stored in the group email store 394. The BellSouth® email profile folder 320 also has SMTP server information 334 and POP3 (or IMAP, for example, among others) server information 336, which provide the information necessary for Curly to connect to the BellSouth® email server.

Similar to Curly's BellSouth® email profile folder 320, Curly's Yahoo® email profile folder 340 includes a user name 342 and a password 344 for Curly's Yahoo® email mailbox. The Yahoo® email profile folder 340 also includes email messages that are directed to Curly's Yahoo® email mailbox. Also, similar to the BellSouth® email profile folder 320, Curly's Yahoo® email profile folder 340 has SMTP server information 348 and POP3 (or MAP) server information 350, which provide necessary information for Curly to connect to the Yahoo® email server.

Additionally, Curly's profile 310 may include an addressbook having a listing of all of Curly's contacts as well as settings 356 for Curly's addressbook. Moreover, Curly's profile 310 may include email rules 352 by which Curly's email messages are sorted, forwarded, deleted, etc. Also, Curly's profile 310 may include a user type that designates whether or not Curly is an administrator, a guest, or a user having limited privileges and access. While not explicitly shown in FIG. 3, it should be appreciated that Curly's BellSouth® IM profile folder 338 may also include a login name and a password associated with Curly's BellSouth® IM account.

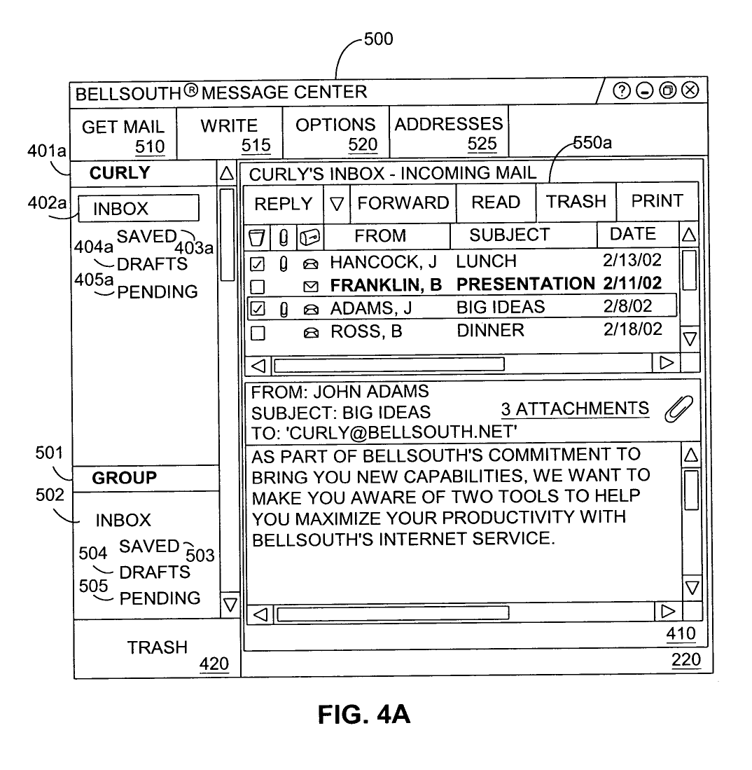

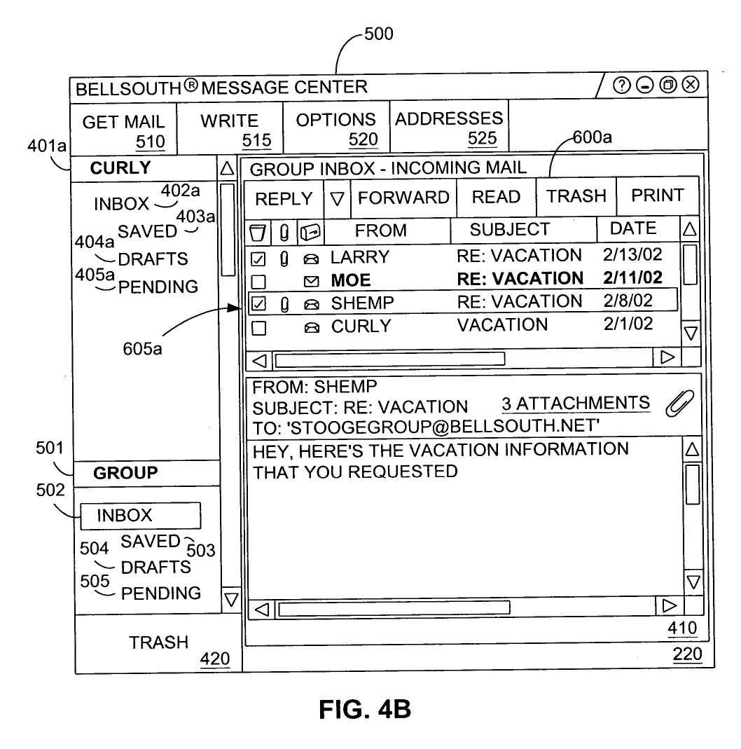

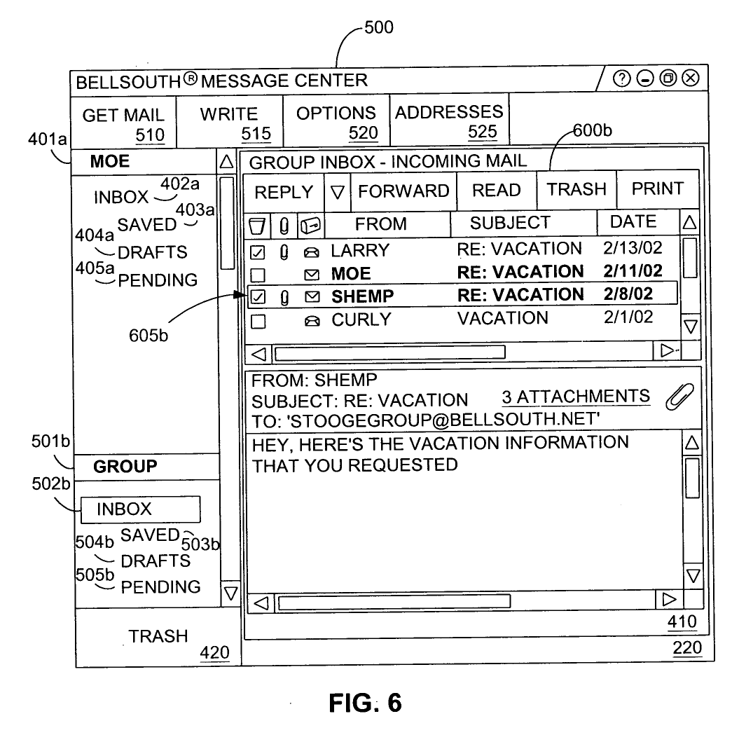

Moe's profile 360, similar to Curly's profile, may include a listing of all of Moe's mailboxes and folders 370, which include a user email profile folder 376 and a group email profile folder 380. The user email profile folder 376 has email messages 378 or pointers to corresponding email messages. Similar to Curly's group email profile folder 330, Moe's group email profile folder has pointers to email messages that are directed to the group. Additionally, Moe's email profile folder may include Moe's user name 372, password 374, SMTP server information 384, POP3 (or IMAP, for example, among others) server information 386, email rules 388, user type 390, and addressbook settings 392. As shown in FIG. 3, Moe's group email profile folder 376 includes pointers 378 to the group email messages, which are located in the group email store 394. By storing the group email messages in a single email store 394, storage space is saved by removing the need to duplicatively store the group email messages at both Curly's profile 310 and Moe's profile 360. In some embodiments, the group email messages are marked with indicators, as described in greater detail with reference to FIGS. 4B and 6, thereby providing a streamlined approach to maintaining and tracking group email messages with reference to the various individual users.

While examples of information related to a user are listed above, it should be appreciated that the user profiles 310, 360 may include any information related to a particular user. Hence, if Curly further defines properties or preferences associated with his email folder, Curly's user profile 310 may include those email properties or preferences defined by Curly. Similarly, if Moe defines such properties, those properties may be included in Moe's profile 360. Each of the properties defined in the user profiles 310, 360 may be used to define properties or preferences of the user's email folder. Similarly, any of the properties related to the users' IM accounts may be used to define the properties or preferences of the user's IM accounts. Embodiments of email clients that implement the user profiles 310, 360 are shown with reference to FIGS. 4A through 7.

FIGS. 4A through 6 show example user interfaces having group email folders. As an example embodiment, the owner of an ISP account may have multiple email mailboxes associated with the ISP account. One of those email mailboxes may be a primary email mailbox, which is assigned to the owner of the ISP account. Thus, for example, if eight email mailboxes are associated with the ISP account, then one email mailbox is assigned to the owner of the ISP account, by default, while the remaining seven email mailboxes may be distributed to different individuals or assigned to different person as for the owner of the ISP account. In this regard, when the owner of the ISP account designates one of the seven email mailboxes as a group email mailbox, the group email mailbox becomes associated with the owner of the ISP account, since the owner of the ISP account controls the characteristics of the group email mailbox. In other embodiments, the group email mailbox may be associated with one of the other individual users, rather than the owner of the ISP account. In this regard, characteristics of the group email mailbox may be controlled by that other individual user.

Upon creation of the group email mailbox, the owner of the ISP account may designate other individual users as “members” of the group. By doing so, the owner of the ISP account provides access to the other individuals so that they may access email messages in the group email mailbox. In this regard, the group email mailbox behaves somewhat similarly with group message boards, which are known in the art.

Once the email mailboxes are set up by the owner of the ISP account, when an individual user logs into his or her email account, that user's individual email messages are retrieved and displayed to the user. In addition, in some embodiments, all mailboxes on an ISP-level account are accessed, and messages are downloaded upon login by any individual. The login by an individual thus preferably results in a retrieval of email messages for the individual and retrieval of email messages directed to the group. Thus, for some embodiments, all email messages for all individual users (including those not logged in) may be retrieved from a POP3 server at substantially the same time. Preferably, in some embodiments, email messages for each of the mailboxes are retrieved sequentially from the POP3 server. The order of retrieval is, preferably, the same for each time that the email client checks the POP3 server for new email messages. Once the email messages have been retrieved from the POP3 server and stored locally, those email messages may be displayed at user interfaces similar to that shown in FIGS. 4A through 6. For other embodiments, when a user logs in, only those mailboxes associated with that user (e.g., individual email mailbox of the user and group email mailbox) may be accessed, rather than downloading all email messages for all users.

FIG. 4A is a block diagram showing an embodiment of an individual user email folder that selectively displays the data structures of FIG. 3. In the example of FIG. 4A, a specific user's email folders (Curly's email folders) are shown as being accessible in an email user interface 500. As shown in FIG. 4A, the email user interface 500 comprises user-selectable icons, such as, for example, a get mail icon 510, a write icon 515, an options icon 520, and an address icon 525. By selecting any of the user-selectable icons, the user may initiate a corresponding email-related process. For example, by selecting the write icon 515, the user may initiate a process that permits the user to write (or compose) an email message. In this regard, the selection of the write icon 515 may open a window in which the user may compose an email message. By selecting the address icon 525, the user may initiate a process that displays the user's addressbook for manipulation thereof. The selection of the get mail icon 510 may initiate a process that retrieves any mail on the user's POP3 email servers. Once retrieved, the email messages are displayed at the inbox 402a on the graphical user interface 500. If email messages are retrieved from multiple servers (e.g., BellSouth®, Yahoo®, etc.), then the inbox 402a may be further sub-divided into sub-folders (not shown). These sub-folders may correspond to the various email folders shown in FIG. 3. It should be appreciated that the email user interface may be configured to perform a variety of conventional email-related tasks, or may be custom configured for added functionality.

The user interface 500 further comprises a graphical representation of an individual user email folder collection 401a, which is labeled “Curly,” and a group email folder collection 501a, which is labeled “group.” In some embodiments, the email user interface 500 is configured to display email messages that are directed to the user, Curly, as well as email messages that are directed to an email address of a group, of which Curly is a member. Other embodiments include displaying all folder collections associated with an ISP-level account. Hence, when email messages are directed to Curly, as an individual user, the email user interface 500 displays those email messages in the user email folder collection 401a labeled “Curly.” Conversely, when email messages are directed to the email address of a group, of which Curly is a member, the email user interface 500 displays those email messages in the group email folder collection 501a. The group email folder collection 501a may be associated with a separate email mailbox that is established by an administrator, which is often the ISP customer, i.e., the user paying for the multiple mailboxes associated with the account. Thus, when the administrator adds Curly as a member of the group, then any email messages that are directed to the group may be accessed by Curly. In other words, for some embodiments, the group email mailbox is simply treated as another of Curly's email mailboxes, but shared with other users. Hence, when Curly executes the email user interface 500, email messages in both Curly's individual user email folder and the group email folder are displayed in separate email folder collections. If, however, Curly is not a member of the predefined group, then the email user interface would only display Curly's individual user email folder collection(s) and not the group email folder collection(s). Details related to the group email folder are described in greater detail with reference to FIGS. 4B and 6. It should be appreciated that, while one group folder collection is shown in the example embodiments, the administrator may set up multiple group folder collections, each of which has a different subset of group members. For embodiments having multiple groups, it should be appreciated that the group folder may be further separated into group sub-folders (not shown) that each correspond to the separate groups. Alternatively, the group folder may display all of the group email messages without segregating them into various group sub-folders.

The user email folder collection 401a is divided into folders such as, for example, an inbox 402a, a saved messages folder 403a, a drafts folder 404a, and a pending email folder 405a. In some embodiments, other folders (e.g., “sent items,” etc.) and subfolders may be established to further organize the various folders. Since the establishing of folders and subfolders are known in the art, further discussion of establishing folders and subfolders is omitted here. The inbox 402a contains incoming email messages for the user associated with one or more mailboxes. Other embodiments include showing additional folder collections for other individual mailboxes, including those mailboxes belonging to the user at the same ISP account, or belonging to the user at other ISP-level accounts and providers. Hence, in the example of FIG. 4A, all of Curly's incoming email is located in Curly's inbox 402a. The saved messages folder 403a contains any email messages that Curly has saved or moved from the inbox 402a to the saved messages folder 403a. The drafts folder 404a contains any outgoing email message that Curly may be composing, but has not yet sent. Hence, if Curly is in the process of composing a message to Moe, then that message will be stored in the drafts folder 404a. The pending email folder 405a contains any email message that is waiting to be transmitted. It should be appreciated that the user email folder collection 401a may be subdivided into a variety of sub-folders according to the desires of the individual user. Since the division of email folders into various folders is known in the art, further discussion of sub-dividing email folders is omitted here.

FIG. 4A specifically shows the inbox 402a of the user email folder collection 401a being selected for viewing. In this regard, once the inbox 402a has been selected, the identifications of email messages contained in the inbox 402a are presented to the user as a list 550a in the email user interface 500. As shown in FIG. 4A, the inbox 402a, which belongs to Curly, contains email messages from J. Hancock, B. Franklin, J. Adams, and B. Ross. Specifically, J. Hancock's email and J. Adams email have attachments to the email, as indicated by the paper-clip icon displayed next to their names in the list 550a. In addition to the list 550a of identifications of email messages, the email user interface may be configured to display a preview of a selected email message. Hence, in the example of FIG. 4A, if J. Adams' email message is selected, then the contents of that email message may be displayed in a preview window below the list 550a of email messages.

An email message that arrives in Curly's inbox 402a is typically assigned an indicator that indicates whether or not the email message has been accessed (e.g., read, selected, opened, etc.) by Curly. Initially, if the email message has not been accessed by Curly, then the indicator may be set to indicate that the email message has not been read. Identifications for those email messages that have not been accessed by Curly may be highlighted, or be different in appearance, than identifications for other email messages that have already been accessed by Curly. For example, as shown in FIG. 4A, the identification of the email message from B. Franklin appears different (e.g., bold text, which is one visual indicator example, among others) from the remaining email messages, thereby indicating that B. Franklin's email message has not yet been accessed (e.g., read or opened) by Curly. When Curly accesses (e.g., selects, highlights, opens, or reads, etc.) the email message from B. Franklin's, the indicator in the email message is typically reset to indicate that Curly has read the email message. In some embodiments, the resetting of the indicator may be represented by, for example, a changing font on an identification of the email message. For example, an accessed message may be represented with a plain text identification while a message that has not been accessed may be represented with a bold text identification. In other embodiments, the resetting of the indicator may be graphically represented using an open-envelope icon and a closed-envelope icon; the open-envelope icon representing an accessed message, and the closed-envelope icon representing a message that has not been accessed (e.g., read, selected, highlighted, opened, etc.). Once the indicator has been reset to show that the email message has been accessed by Curly, the appearance of the email message identification may be changed to a similar appearance as the other email messages that have already been accessed by Curly (e.g., normal text).

In addition to the open- and closed-envelope icons, additional icons may be graphically provided to the user to facilitate other known email functions. For example, a check-box may be displayed next to each email message identification, so that a user may select multiple email messages for deletion. Thus, for example, if J. Hancock's email message and J. Adams' email message have their respective check-marks selected, then those email messages may be deleted substantially simultaneously by a single click of the “trash” button. Since various functions and their corresponding icons are known in the art, further discussion of such graphical displays is omitted here.

The group email folder collection 501a, similarly, may be divided into folders such as, for example, an inbox 502a, a saved messages folder 503a, a drafts folder 504a, and a pending email folder 505a. Since the various email folders and sub-folders in the group email folder collection 501a are somewhat similar to the email folders in the individual user email folder collection 401a, further discussion of email folders and sub-folders is omitted here. However, FIG. 4B shows, in greater detail, various additional aspects of the group email folder collection 501a.

FIG. 4B is a block diagram showing an embodiment of a group email folder that selectively displays the data structures of FIG. 3. The example of FIG. 4B shows further aspects of Curly's email, specifically those aspects related to the group email folder. As discussed above, email messages that are directed to the group email mailbox are downloaded and stored in the inbox 502b of the group email folder collection 501b. Thus, when the user (Curly, in the example of FIG. 4B) selects the inbox icon 502b of the group email folder collection 501b, then a list 600a of group email message identifications is displayed to the user. Specifically, FIG. 4B shows identifications of email messages to the group from Larry, Moe, Shemp, and Curly. As shown in FIG. 4B, the email message identification from Moe appears different from the identifications of other email messages, thereby indicating that Moe's email message has not yet been accessed (e.g., read or opened) by Curly. Similar to the individual user email folder, the email messages in the group email folder have an indicator that indicates whether or not the email message has been accessed (e.g., read, selected, opened, etc.) by a particular user. Unlike messages in the individual user email mailbox, which are usually accessible by only one associated user, the messages in the group email mailbox are accessible by every member of the predefined group. Hence, if both Curly and Moe are members of the predefined group, then both Curly and Moe may access the email messages from the group email mailbox. For this reason, each email message in the group email folder collection 501b preferably has a separate indicator for each of the predefined members of the group. The separate indicators for each of the users are also referred to herein as access indicators. Thus, for example, if both Curly and Moe are members of the predefined group, then the email message may have a first indicator for Curly and a second indicator for Moe. Hence, when Curly accesses an email message in Curly's group email folder collection 501a, then the first indicator may be reset to indicate that Curly has accessed the email message. Thus, even though the first indicator may be altered when Curly accesses the group email message, the second indicator may be unchanged if Moe has not accessed the email message. In this regard, user-based access indicators facilitate organization of group email messages on an individual-by-individual, or user-by-user, basis.

In addition to access indicators, each email message in the group email folder collection 501 may also have other user-based indicators that indicate whether or not their respective users have deleted the group email message (e.g., user-based delete indicators), saved the group email message to another folder (e.g., user-based save indicators or user-based move indicators), replied to the group email message (e.g., user-based reply indicators), forwarded the group email message (user-based forward indicators), etc. The separate indicators for each of the group members allow each of the members to alter properties (e.g., read, not read, deleted, moved, etc.) of the group email messages without affecting the properties of the group email messages as displayed to the other members. In other words, by having separate user-based access indicators, the email message may effectively be displayed uniquely for each member.

Of course, other embodiments include other mechanisms for accomplishing one or more of these, or other, functions. In addition, while these group message management and group authorization functions are performed at the client level in some embodiments, other embodiments include performance of similar functions at the server level.

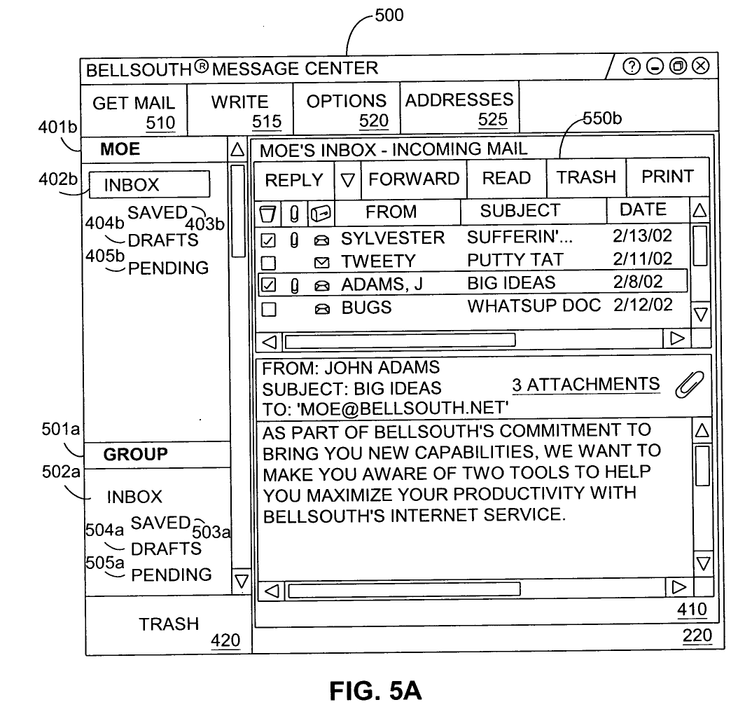

FIG. 5A is a block diagram showing another embodiment of an individual user email folder that selectively displays the data structures of FIG. 3. In the example of FIG. 5A, another user's email folders (Moe's email folders) are shown. Similar to Curly's example of FIG. 4A, Moe's email folders are divided into a user email folder collection 401b and a group email folder collection 501b. The user email folder collection 401b is configured to store all email messages that are specifically directed to Moe as a user, while the group email folder collection 501 is configured to store all email messages that are directed to the group, from Moe's perspective as a member. In the specific example of FIG. 5A, Moe is a member of the same group in which Curly is a member. Hence, the storage for the group email folder collection 501a is shared by both Curly and Moe. Further details related to the group email folder collection 501a, 501b are discussed with reference to FIG. 4B above and FIG. 6 below.

As shown in FIG. 5A, when Moe executes the email user interface 500, only those folders for mailboxes that are accessible by Moe are displayed to Moe. In other words, Moe's user email folder collection 401b, and all of its folders, display only those email messages that have been directed to Moe. Similarly, as shown in FIG. 4A above, when Curly executes the email user interface 500, only those email folders, subfolders, and email messages that are accessible by Curly are displayed for Curly. Thus, as shown in FIG. 5A, when Moe selects the inbox 402b folder, all of Moe's incoming email messages are displayed to Moe as a list of email identifications 550b. In the example of FIG. 5A, Moe has email messages in his inbox 402b from Sylvester, Tweety, J. Adams, and Bugs. Unlike Curly's inbox 402a, all of the messages in Moe's inbox 402b are indicated as being read. In this regard, it appears that in the embodiment of FIG. 5A, Moe does not have any unread email messages in his inbox. Similar to the indicators for Curly's email messages, each of Moe's email messages preferably have indicators that indicate whether or not Moe has accessed the email message. Since the indicators in email messages for a user's email folder are described above with reference to FIG. 4A, further discussion of indicators in user email messages is omitted here. In a preferred embodiment, the indicator may be an extensible markup language (XML) tag that may be set or reset to indicate that a user has or has not accessed the user's email message. Alternatively, the indicator may be, among others, a hypertext markup language (HTML) tag that performs similar functions. It should be appreciated by those of skill in the art that the indicator may be implemented as a software flag that may be set or reset to indicate corresponding properties of the email message.

As shown in FIGS. 4A and 5A, if J. Adams sends an email message to both Moe and Curly, then that email message will appear in the inbox 402a, 402b for both Moe and Curly. Thus, unlike a single email message that is directed to the group email mailbox, when both Curly and Moe are listed as individual recipients on an email message, two separate email messages are sent to each of Moe and Curly's respective email mailboxes. In other words, one email message is received at Moe's individual user email mailbox, and the other email message is received at Curly's individual user email mailbox. Since both of these email messages are separately handled by Curly and Moe's respective email mailboxes, the handling of the email message by Moe is independent of the handling of the email message by Curly. FIG. 6 shows the handling of group email messages and further emphasizes the difference between group email messages (email messages directed to a group) and user email messages (email messages directed to individual users).

FIG. 6 is a block diagram showing another embodiment of a group email folder that selectively displays the data structures of FIG. 3. Specifically, FIG. 6 shows the group email folder that is accessible by Moe, which represents email messages that have been downloaded from the group email mailbox, which is effectively accessible by both Moe and Curly. In this regard, the body of the email messages in FIG. 6 is identical to the body of the email messages in FIG. 4B. However, as shown in FIG. 6, unlike Curly's group inbox 502a, Moe's inbox 502b shows that neither the email message from Moe nor the email message from Shemp have been previously viewed. Hence, both of those email message identifications appear different (e.g., bold font) from the email message identifications from Larry and Curly (e.g., normal font). In other embodiments, the email client may be configured to reset the indicator when the email messages have only been viewed in, for example, a separate read window.

As discussed above, each email message that is directed to the group email folder includes indicators, such as, for example, XML tags. Each of the indicators are respective to each of the members of the group. Hence, if the group consists of Curly and Moe, then the email message to the group will have at least two indicators: one indicator for Curly, and another indicator for Moe. In the examples of FIGS. 4B and 6, each group email message includes at least an access indicator that indicates whether or not each member of the group has accessed the email message. However, it should be appreciated that the email message may also include delete indicators for each user, reply indicators for each user, forward indicators for each user, or any other type of indicator, as described above.

While email messages sent to individual user email folders are stored in duplicate if there are multiple recipients, the email messages sent to the group folder are not normally duplicated in storage. Rather, indicators are used for the email messages (e.g., whether or not accessed (read, opened, deleted, replied to, forwarded, etc.)) to distinguish how each member of the group has disposed of the email message. In this regard, the storage space associated with each email message is reduced by removing the need for duplicative email messages. Such advantage is gained on the server and client levels for client-based implementations.

Also, while FIGS. 4A through 6 show only the group email folder and the individual email folder for the individual logged in at that moment, it should be appreciated that every individual email folder for all users may be displayed at a single interface. For those embodiments, each individual folder may be password protected or “locked.” Example embodiments, in which all user folders are shown, are provided in co-pending U.S. patent application [attorney docket no. 190250-1310], entitled “USER INTERFACE FOR A COMMUNICATION SUITE,” filed on Oct.14, 2003, which is incorporated herein by reference as if set forth in its entirety. Since embodiments of such user interfaces, and their underlying mechanisms, are described in great detail in the above-referenced patent application, further discussion of such user interfaces and their underlying mechanisms is omitted here.

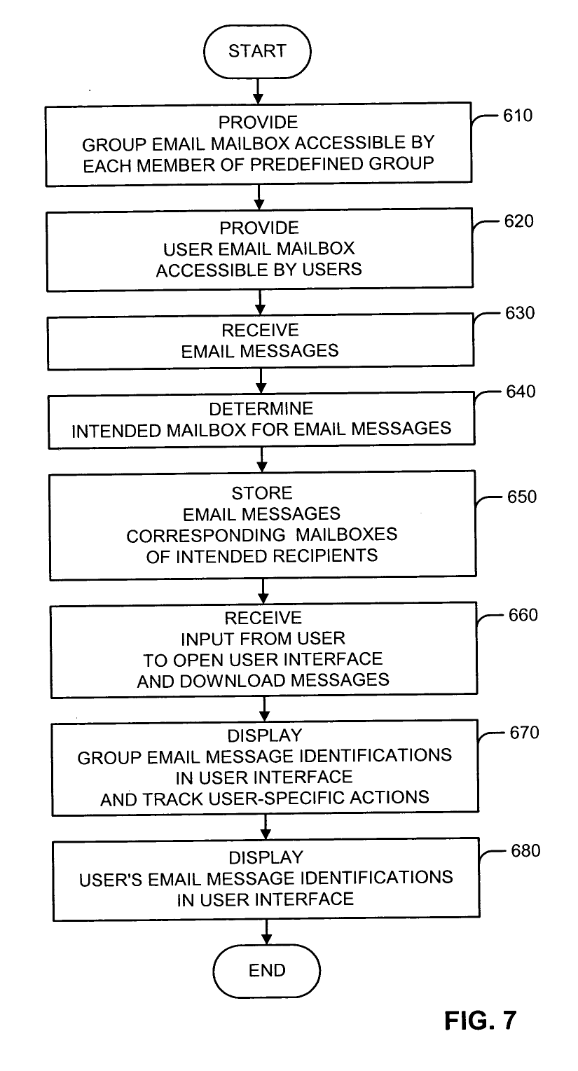

Having described several embodiments of systems for managing multiple email mailboxes and/or folders, attention is turned to FIG. 7, which show several embodiments of methods for managing multiple email mailboxes and/or folders.

FIG. 7 is a flowchart showing an embodiment of a method for managing multiple email mailboxes. As shown in FIG. 7, in some embodiments, a group email mailbox is provided (610) for receiving, storing, and enabling access to messages by each member of a predefined group. Some client-based embodiments include any user being enabled to download messages from a group mailbox for subsequent local access by all members of the group, while other (server-based) embodiments provide for direct access of the mailbox by all members. Thus, the mailbox is considered directly or indirectly accessible by each member of the group in both types of embodiments, among others. An administrator of a system, such as, for example, an ISP-level account subscriber or other user, may establish the predefined group. In this embodiment, the process further comprises the step of providing (620) individual user email folders to individual users. Hence, for example, if a primary user (also referred to herein as an administrator) is provided an account from an Internet service provider (ISP), that primary user may establish individual email folders that are provided to individual users. In addition to the individual email folders, the primary user may also establish a group email folder and provide access of that group email folder to the other individual users. Thus, as with other disclosed processes, the order of the steps in FIG. 7 is not intended to be limiting. In other words, other implementations may include the steps of FIG. 7 performed out of order.

This embodiment of the process may be seen as further comprising the step of receiving (630) email messages and determining (640) the intended recipients of the email messages. Hence, for example, if folders are provided for Moe, Curly, and a group to which Moe and Curly belong, then, for each received email message, it is determined whether that email message was directed to Moe, directed to Curly, or directed to the group. Upon determining (640) the intended recipient, the email messages are stored (650) in their corresponding email mailboxes. Hence, if the email message is directed to Moe, then the email message is stored in Moe's email mailbox; if the email message is directed to Curly, then the email message is stored in Curly's email mailbox; if the email message is directed to the group, then the email message is stored in the group email mailbox. Since the various email mailboxes are discussed above, further discussion of these mailboxes is omitted here. It should be appreciated that, if the email message is directed to Moe and Curly as individuals, then the email message will be stored in both Curly's email mailbox and Moe's email mailbox. In this regard, an email message that is individually directed to both Curly and Moe will not be stored in the group email mailbox unless it is also specifically directed to the group. Steps 610 and 620 typically include initial set up input from a user, and steps 630 through 650 may include conventional routing and storage of email messages at a main server.

When a user provides an input to open (or execute) an email user interface, the input is received (660). In a client-based implementation, such as POP3, upon executing the email user interface, a user may login, and email messages are downloaded into client inbox folders, and identifications of the group email messages are displayed (670) to the user with tracking of user-specific actions, and the identifications of the user's email messages are displayed (680) to the user at the email user interface. Thus, for example, if Moe opens an email user interface, then Moe will have access to all email messages directed to Moe as well as all the email messages directed to the groups, of which Moe is a member. In some embodiments, the email user interface for the messages directed to Moe may be similar to that shown in FIGS. 5A and 6. In another example, if Curly opens an email user interface, then Curly will have access to all email messages directed to Curly as well as all the email messages directed to the groups, of which Curly is a member. In some embodiments, the email user interface for the messages directed to Curly may appear as that shown in FIGS. 4A and 4B. As shown in FIG. 7, by providing both individual user email folders and group email folders, a user may access email messages that are specifically directed to the user in addition to email messages that are directed to the group, of which that user is a member

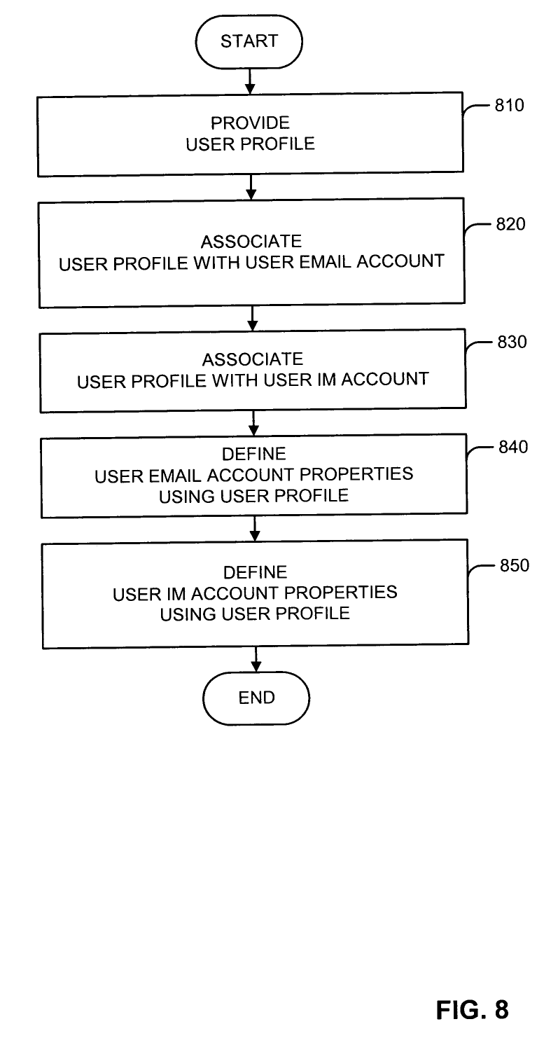

FIG. 8 is a flowchart showing yet another embodiment of a method for managing multiple email folders. As discussed with reference to FIG. 3 above, each user may be associated with a user profile. The user profile may be used to define properties associated with the user's email folders and IM accounts. In this regard, one embodiment of the process may be seen as comprising the steps of providing (810) a user profile, which includes a collection of properties or preferences for email folders and IM accounts. The user profile is associated (820) with the user's email folder and, also, associated (830) with the user's IM account. Properties or preferences of the user's email folder are then defined (840) using the user's profile. Similarly, properties or preferences of the user's IM account are also defined (850) using the user's profile. In this regard, the user profile may be used to define the properties or preference of all of the user's digital communications media.

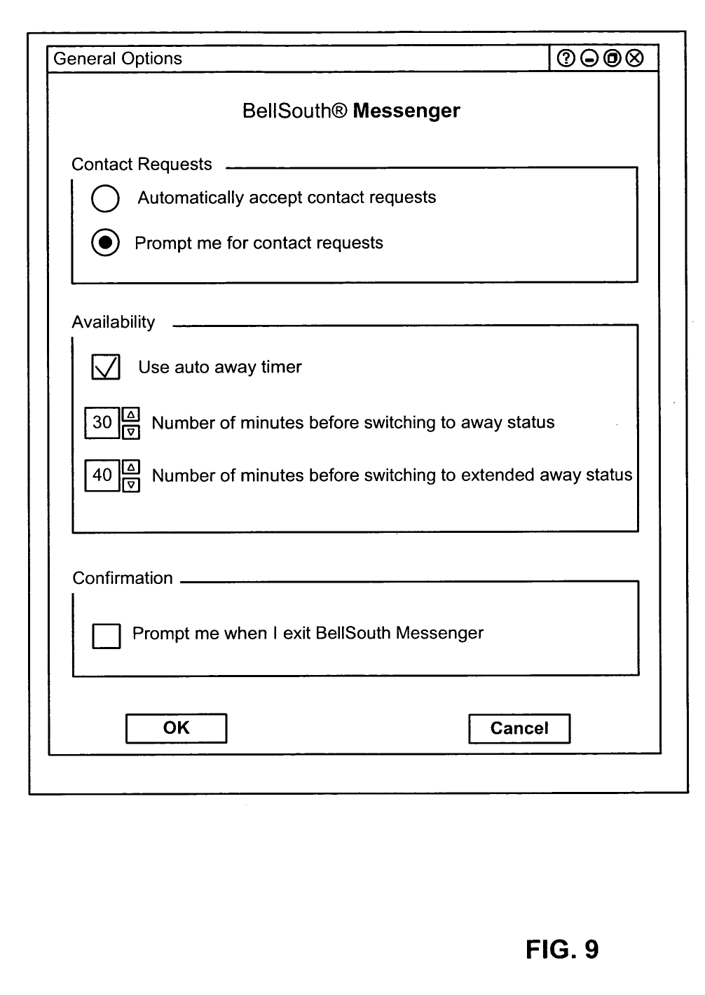

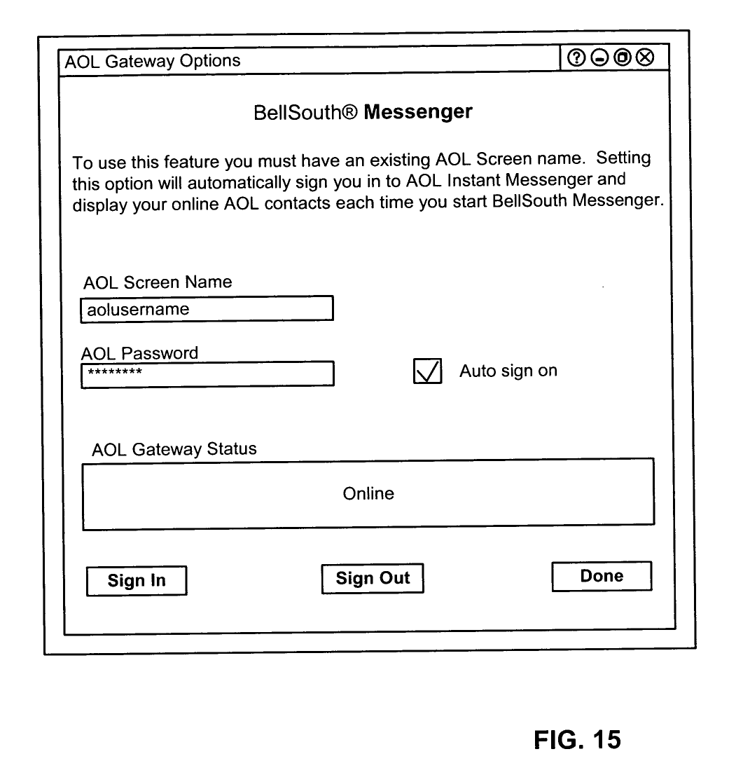

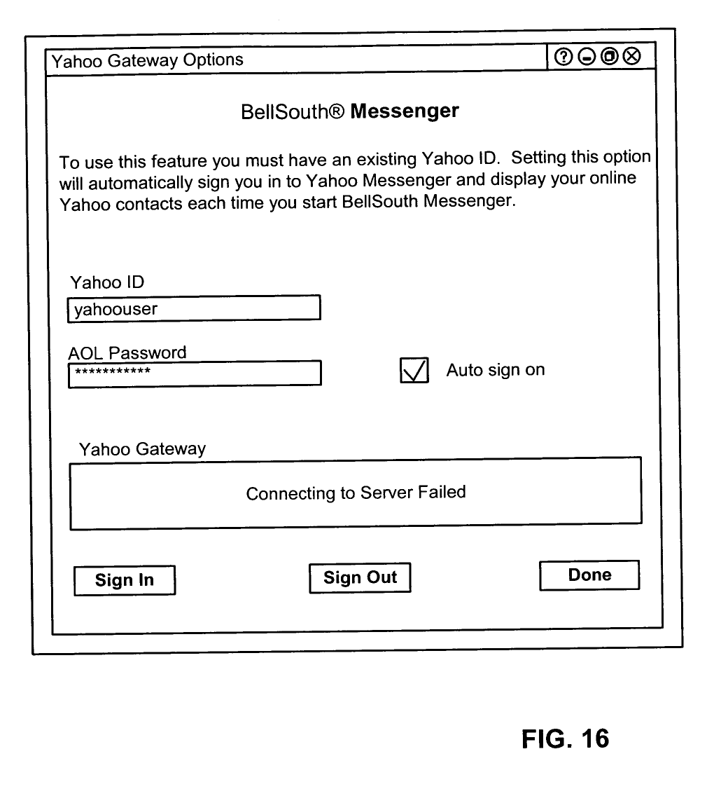

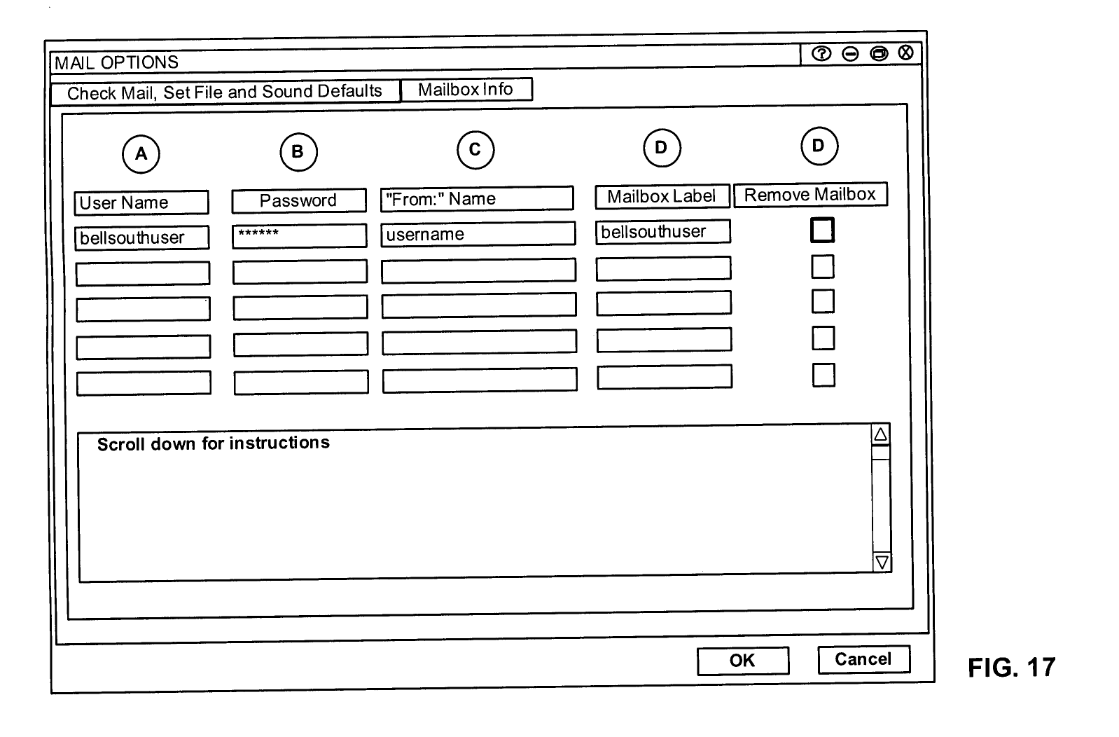

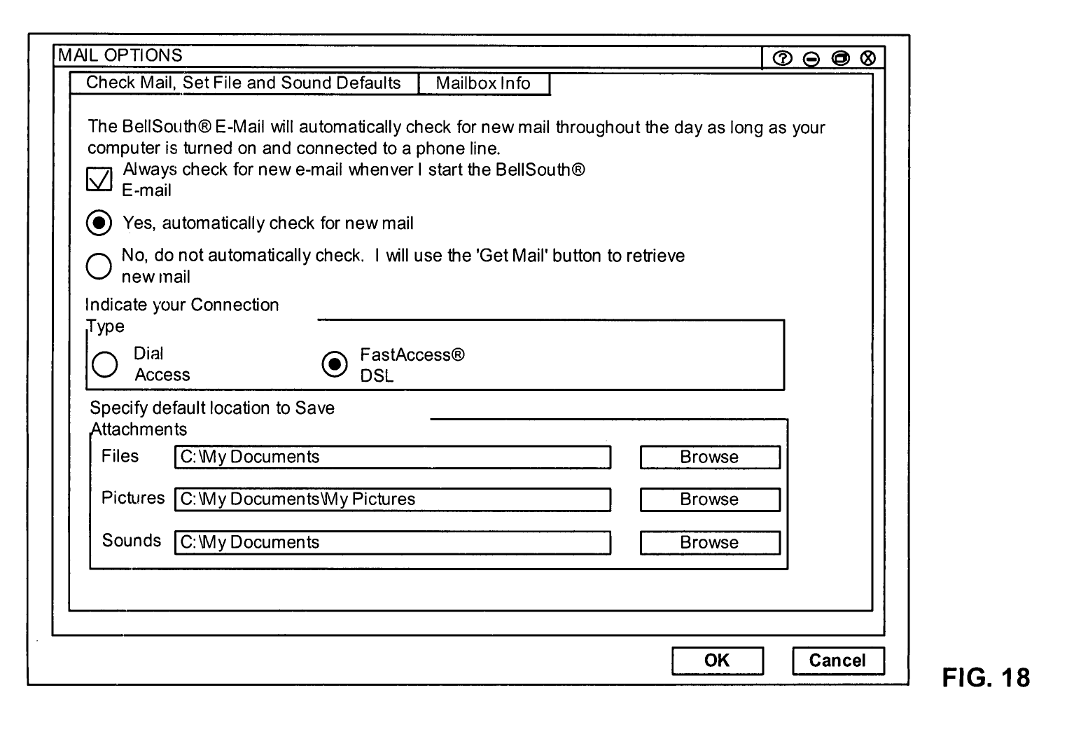

As discussed with reference to FIGS. 3 and 8, a single database having both email and IM information for a particular user may facilitate integration between email and IM systems. Specific examples of graphical user interfaces (GUIs) for an embodiment of an instant messaging (IM) system are shown in FIGS. 9 through 16, and examples of GUIs for an embodiment of an email system are shown in FIGS. 17 and 18. It should be appreciated that, while FIGS. 9 through 16 are associated with an IM application and FIGS. 17 and 18 are associated with an email application, the preferences saved through the GUIs are, in some embodiments, stored at a common database. In other words, while the input mechanism itself may be associated with two different software applications, the resulting storage location is a centralized location that stores both email and IM profiles, similar to that shown in FIG. 3.

FIGS. 9 through 16 are example graphical user interfaces (GUIs) in an embodiment of a system for storing instant messaging (IM) profile information in the database of FIG. 3.

As shown in FIG. 9, for some embodiments, an IM option may be associated with contact requests, a user's availability, and confirmation for shutdown. For example, a user may set an option to automatically accept contact requests or, alternatively, may set the option to confirm all contact requests. In setting a user's availability options, the GUI may provide a toggle box (e.g., check box) that permits a user to activate a clock, which tracks the user's activity at the IM application. When the box is selected, then the user may further be provided with an input area in which that user may provide a time interval for which the clock would track elapsed time. That time interval may be a trigger to switch a user's status to “away” or “extended away.” Since the switching of various statuses is know in the art, further discussion of status-setting or status-switching mechanisms is omitted here. However, it should be noted that these various options, when set by the user, are saved to a database having the user's profile information for both email and IM, as shown in, for example, FIG. 3.

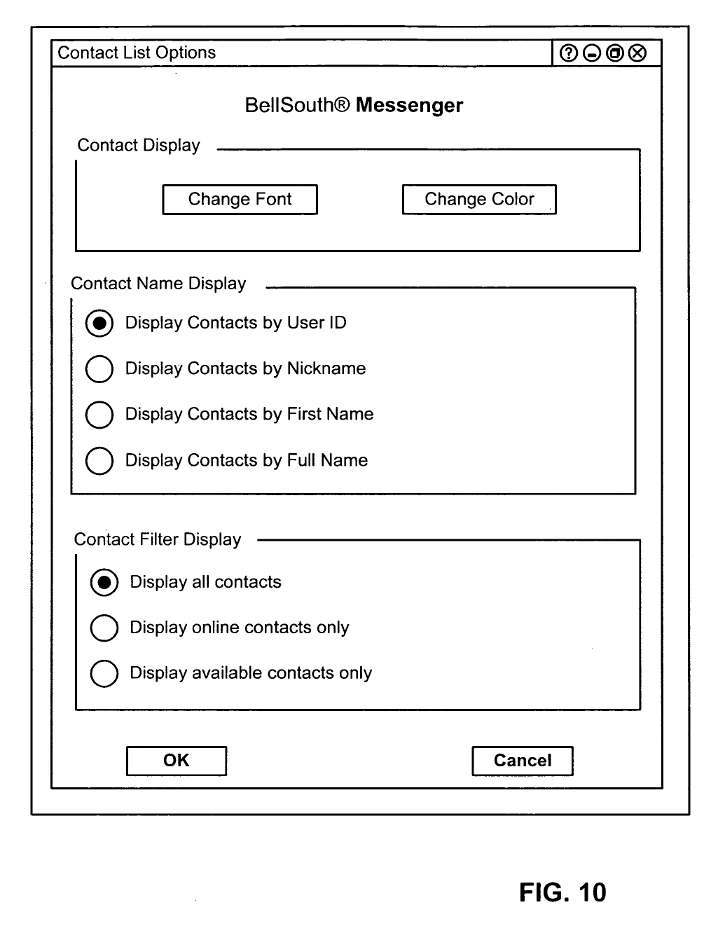

FIG. 10 is an example GUI for entering options related to a contact list. As shown in FIG. 10, the contact list options may include display options such as fonts and colors, a preference related to how contact information will be displayed, and whether or not all contacts should be displayed. In an example embodiment, the preference on how the contact should be displayed may include options such as, for example, displaying contacts by the contact's login name (e.g., their user ID on the system), by a designated nickname (which may be supplied by the user), by the contact's first name (which may also be supplied by the user), or by the contact's full name (which may also be supplied by the user). The option to display subsets of users may include the option to display all contacts for the user, the option to display only those contacts that are present online (as defined in RFC 2778 and RFC 2779), and the option to display only those contacts that are present and available (as defined in RFC 2778 and RFC 2779). Again, since these options are known in the art, further discussion of these options is omitted here. However, it should be appreciated that, once set by the user, these options would also be stored in the database, as shown in, for example, FIG. 3.

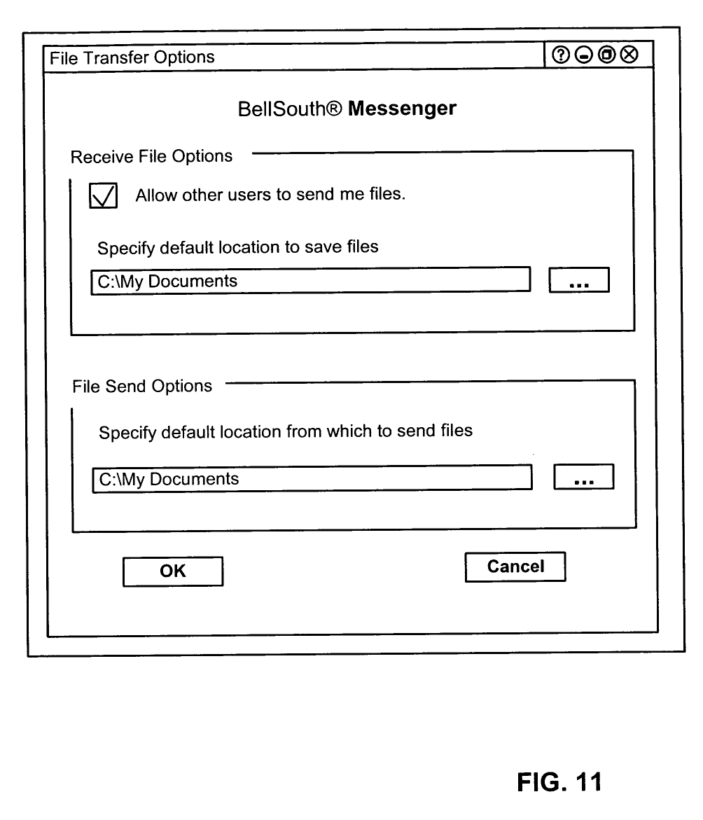

FIG. 11 is an example GUI for entering options related to file transfers. As shown in FIG. 11, the file transfer options may include a user-selectable toggle box that permits the user to restrict incoming files. For example, if the toggle-box is selected, then others may be permitted to send the user files using IM protocols. If, however, the toggle-box is not selected, then file transfer from others may be restricted. In addition to the toggle-box, the default location for storing received files may be specified by the user. Similarly, the default location for outgoing files may also be specified by the user. Since these options are known in the art, further discussion of these options is omitted here. However, it should be appreciated that these options, in addition to those mentioned above, may be stored in, for example, the database of FIG. 3, thereby permitting a centralized storage of both email and IM preferences.

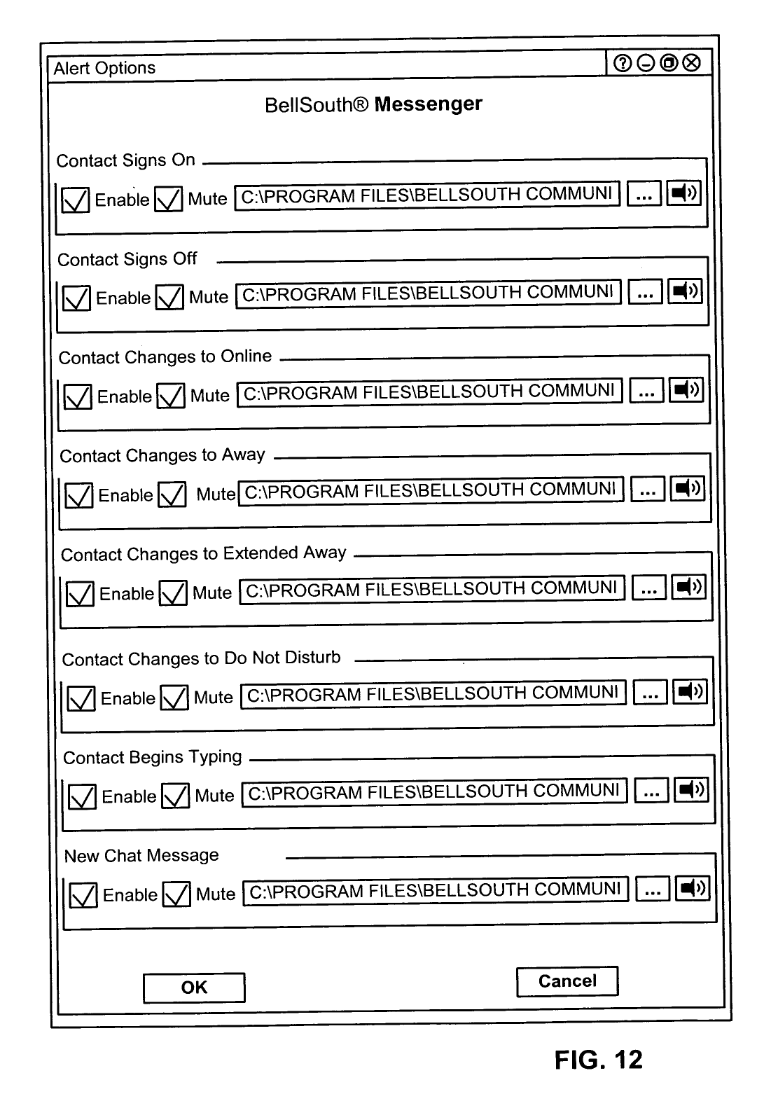

FIG. 12 is an example GUI for setting alert options. The alert options may include one or more toggle-boxes that permit the user to “enable” or “disable” certain alerts. For example, when the toggle-box is selected, a particular alert associated with the toggle-box may be enabled while, conversely, when the toggle-box is not selected, the particular alert associated with the toggle-box may be disabled. When a particular alert is enabled, then the user may further specify the type of notification associated with that alert. The type of notification may include different sounds (e.g., .wav files). The alert options may include, but are not limited to, alerts that indicate that a contact has logged into IM, alerts that indicate that a contact has logged off of IM, alerts that indicate that a contact's status (e.g., away, extended away, available, do not disturb, etc.) has changed, alerts that indicate that a contact is typing a message to the user, alerts that indicate that a new chat message has arrived. Similar to the preferences of FIGS. 9 through 11, these preferences may also be stored at the centralized database, as shown in, for example, FIG. 3.

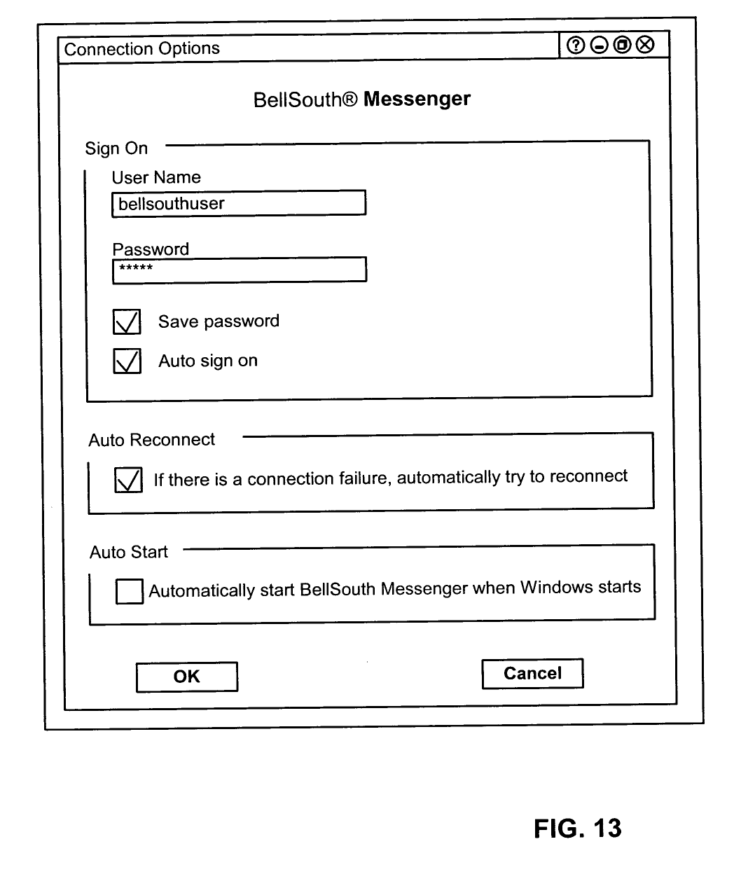

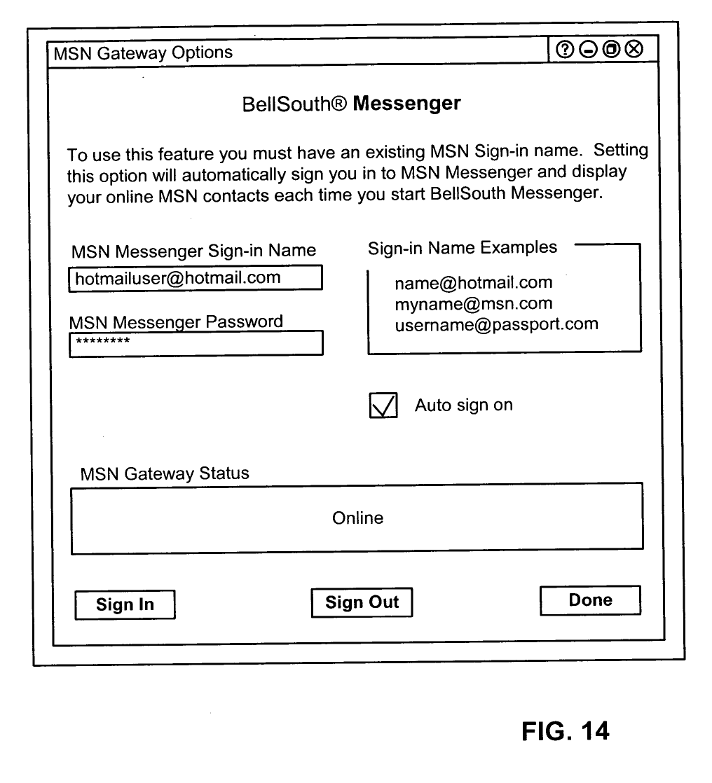

FIGS. 13 through 16 are example GUIs for setting connection options. In some embodiments, the IM application may be configured to support IM communications between various IM protocols. Since these protocols and their interoperability are discussed fully in the above-referenced patent applications, further discussion of IM interoperability is omitted here. However, as shown in FIGS. 13 through 16, each of the user's IM account information may be entered at a different user interface. For example, if the user has a BellSouth® IM account, an MSN® IM account, an AOL® IM account, and a Yahoo® account, then a separate user interface may be provided for the entry of connection information related to each of the IM accounts. As shown in FIG. 13, the user's BellSouth® IM account may be input at a GUI. The GUI may provide an input area for the user's login name for the user's BellSouth® IM account; an input area for the user's password; a user-selectable toggle-box for setting whether or not that password should be saved; a user-selectable toggle-box for setting whether or not the user should be automatically logged in upon startup; a user-selectable toggle-box for setting whether or not a connection should be established in the event of a disconnect, etc. Similar input areas may be provided for the user's MSN® IM account, the user's AOL® IM account, and the user's Yahoo® IM account, as shown in FIGS. 14 through 16. All of this information is stored in a centralized database, such as, for example, the database shown in FIG. 3. In this regard, every user-settable option may be stored at the database, thereby permitting the user's IM application to retrieve the information from a central repository.

In addition to the user's IM information, the user's email information may also be stored in the database of FIG. 3. Examples of a user's email information are provided in FIGS. 17 and 18. Specifically, FIGS. 17 and 18 are example GUIs in an embodiment of a system for storing email profile information in the database of FIG. 3.

As shown in FIG. 17, a user's mail options may be set using a GUI. The GUI may be associated with an email application and, in that regard, may have no relevance to IM. However, all of the user's email information may be stored in the same database that stores the user's IM information, thereby providing a central repository for both IM and email information related to a user. In this regard, when a user chooses to migrate from one machine to another, rather than copying multiple files, a single file having all of the user's information may be copied, thereby simplifying the migration process. As shown in FIG. 17, a user's email options may include a user's login name, password, folder label, etc., which are known in the art and not further discussed herein. As shown in FIG. 18, a user's email options may further include email connection options, options related to the frequency of checking for incoming email messages, file locations, etc., which are also known in the art and not further discussed herein. These email options, as noted above, are saved at the central repository so that both email and IM preferences for a particular user may be consolidated into a single file.

As discussed with reference to FIGS. 3 and 8 through 18, greater integration between IM and email is achieved by consolidating the information into a single repository, such as, for example, the database shown in FIG. 3.

The email client 260, the email user interface logic 290, and the email user interface 500 of FIGS. 4A through 6 of the present disclosure can be implemented in hardware, software, firmware, or a combination thereof. In the preferred embodiment(s), the email client 260, the email user interface logic 290, and the email user interface of FIGS. 4A through 6 are implemented in software or firmware that is stored in a memory and that is executed by a suitable instruction execution system. If implemented in hardware, as in an alternative embodiment, the email client 260, the email user interface logic 290, and the email user interface of FIGS. 4A through 6 can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. Also, while only the user interfaces are shown in FIGS. 4A through 6, it should be appreciated that the underlying logical components used implement the user interfaces may include any of the above-mentioned hardware components.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

The email client 260 and the email user interface 500 of FIGS. 4A through 6, and the indicators, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Also, it should be appreciated that the embodiments taught above may be implemented at the client-side, the server-side, or a combination of the client- and server-side. For client-side implementations, one of ordinary skill in the art will appreciate that multiple email clients may result in email messages being stored at different client locations. Hence, it should be appreciated that a user may select an option to maintain email messages at the server, rather than retrieving email messages from the server and storing them at each client location. Similarly, it should be appreciated that a user may retrieve email messages at one client and set any other email client to maintain a copy of the email messages at the server. Since these options are known to those skilled in the art, further discussion of these options is omitted here. Also, it should be appreciated that if the embodiments are implemented at the server-side, the components shown in FIGS. 2A, 2B, and 3 may reside at a server, rather than at a client. For example, tracking of user-based access may be implemented at the server level using corresponding logic. Similarly, access to group mailboxes may be provided to multiple users at the server level. Moreover, for web-based email access, the web email client may be a browser rendering web pages that are specifically configured to provide access to the mailboxes through the browser's graphical user interface.

It should be appreciated that, while both client-side and server-side implementations are disclosed, for purposes of clarity, the client-side representations of stores of messages are referred to, in general, as folders or collections of folders, while those on the server-side are referred to, in general, as a mailboxes, some of which have associated folders, in some embodiments.

Additionally, for some client-based embodiments, it should be appreciated that no change to the POP3 (or other) server is needed, since the bulk of the email processing and sorting occurs at the client-side.

Although exemplary embodiments have been shown and described, it will be clear to those of ordinary skill in the art that a number of changes, modifications, or alterations may be made, none of which depart from the spirit of the present disclosure. All such changes, modifications, and alterations should therefore be seen as within the scope of the present disclosure.

1. An email system comprising:
(A) multiple email folders, the multiple email folders comprising:
(A1) a group email folder having group email messages, the group email folder being accessible by each member of a predefined group;
(A2) a first individual-user email folder having first-user email messages, the first individual-user email folder being accessible only by a first user, the first user being a member of the predefined group; and
(A3) a second individual-user email folder having second-user email messages, the second individual-user email folder being accessible only by a second user, the second user being a member of the predefined group; and
(B) an email application being executable by the first user, the email application further being executable by the second user, the email application comprising:
(B1) first display logic configured to display only first-user email messages and group email messages in response to the email application being executed by the first user; and
(B2) second display logic configured to display only second-user email messages and group email messages in response to the email application being executed by the second user.

2. A software application for handling email messages, the application comprising:
a group mail store adapted to store a group email message, the group email message being accessible by members of a predefined group;
an individual mail store adapted to store an individual-user email message, the individual-user email message being accessible by an individual user; and
a user interface having a first section, the user interface further having a second section, the first section being adapted to display the group email message, the second section being adapted to display the individual-user email message.

3. A communication system comprising:
means for providing a group email folder accessible by each member of a predefined group; and
means for providing a first individual-user email folder accessible by a first user, the first user being a member of the predefined group.

4. A communication system comprising:
a group email folder accessible by each member of a predefined group;
a first individual-user email folder accessible by a first user; and
an email application executable by the first user, the email application being configured to display the group email folder and the first individual-user email folder in response to being executed by the first user.

5. The system of claim 4:
wherein the group email folder has a group email message, the group email message being directed to the members of the predefined group; and
wherein the first individual-user email folder has a first-user email message, the first-user email message being directed to the first user.

6. The system of claim 5, wherein the email application is further configured to display the group email message and the first-user email message.

7. The system of claim 6, wherein the email application comprises:
a group email window configured to display the group email message; and
a first-user email window configured to display the first-user email message.

8. The system of claim 4, further comprising:
a second individual-user email folder accessible by a second user, the second user being a member of the predefined group

9. The system of claim 8, wherein the email application is configured to display only the group email folder and the first individual-user email folder in response to being executed by the first user.

10. The system of claim 8, wherein the email application is configured to display only the group email folder and the second individual-user email folder in response to being executed by the second user.

11. A communication method comprising the steps of:
providing a group email folder accessible by each member of a predefined group; and
providing a first individual-user email folder accessible by a first user, the first user being a member of the predefined group.

12. The method of claim 11, further comprising the step of:
displaying the first individual-user email folder and the group email folder using a single user interface.

13. The method of claim 11, further comprising the steps of:
receiving a group email message directed to the members of the predefined group;
receiving a first-user email message directed to the first user;
displaying the group email message in a group email window; and
displaying the first-user email message in a first-user email window.

14. The method of claim 11, further comprising the steps of:
providing a second individual-user email folder accessible by a second user, the second user being a member of the predefined group.

15. The method of claim 14, further comprising the steps of:
receiving a group email message directed to the members of the predefined group;
receiving a first-user email message directed to the first user;
receiving a second-user email message directed to the second user;
displaying only the group email message and the first-user email message in response to an input by the first user.

16. The method of claim 14, further comprising the steps of:
receiving group email messages directed to the members of the predefined group;
receiving first-user email messages directed to the first user;
receiving second-user email messages directed to the second user;
displaying only the group email messages and the first-user email messages in response to an input by the first user.

17. The method of claim 14, further comprising the steps of:
receiving group email messages directed to the members of the predefined group;
receiving first-user email messages directed to the first user;
receiving second-user email messages directed to the second user;
displaying only the group email messages and the second-user email messages in response to an input by the second user.
